(19) United States
(12) Patent Application Publication
(10) Pub. No.: US 2012/0262462 A1
(43) Pub. Date: Oct. 18, 2012

(54) PORTABLE ELECTRONIC DEVICE FOR DISPLAYING IMAGES AND METHOD OF OPERATION THEREOF

(76) Inventors: Johan Montan, Malmo (SE); Klas Tauberman, Akarp (SE); Henrik Sandstrom, Hassleholm (SE)

(21) Appl. No.: 13/088,967

(22) Filed: Apr. 18, 2011

(51) Int. Cl. G06T 13/00

(52) U.S. Cl. 345/473

(57) ABSTRACT

An electronic device having a display screen, one or more processors, and memory, and a method of operation thereof for displaying images is disclosed. The method comprises displaying a first image in a default position in a display area of the display screen. The method further comprises replacing the first image with a second image in the display area of the display screen, wherein the replacing of the first image by the second image is animated in the display area by the second image moving in from the edge of the display area to the default position and the first image simultaneously moving away from the default position with translational speed slower than that of the movement of the second image. The display screen may be a touch-sensitive display screen. The animation to replace the first image by the second image is initiated in response to a swipe gesture on the touch-sensitive display screen, and the speed of the animation may be a function of the speed of the swipe gesture.

### TECHNICAL FIELD

The disclosed embodiments relate to an electronic device, and in particular to a portable electronic device, and a method of operation thereof for displaying images, such as digital photographs.

### BACKGROUND

Portable electronic devices have recently become popular and certain electronic devices can be used for one or more of a variety of functions, such as data and voice communications using a wireless communications unit, image and video capture using a camera, and audio recording and reproduction using a microphone and speaker. Such electronic devices may also have a display screen and on which there can be displayed digital images for example which have been captured by an integrated camera and stored in a memory of the electronic device, or which have been received at the device by data communication.

Efforts are ongoing to increase the functionality and usability of these portable electronic devices, in order to facilitate user interaction therewith. A user interface (UI) that is amenable to a user can allow efficient interaction with the device, enabling a better control of the technical functions of the device, and can avoid the user becoming frustrated with the device and stopping using the device completely.

### BRIEF DESCRIPTION OF THE DRAWINGS

The present disclosure and the embodiments set out herein can be better understood by reference to the description of the embodiments set out below, in conjunction with the appended drawings which can be described as follows.

FIG. 1 is a block diagram illustrating a portable electronic device in accordance with some embodiments.

FIGS. 2A-2E illustrate a display of a portable electronic device in accordance with some embodiments showing a transition animation between images in a display area.

FIG. 3 is a flowchart illustrating a process in accordance with some embodiments for handling user input to control the displaying on the display of a portable electronic device of a transition animation between images in a display area.

### DESCRIPTION OF EMBODIMENTS

Embodiments set out in this application relate generally to a method of animating a transition from one image to another image for example in a picture viewer application on an electronic device such as a portable electronic device.

Embodiments may facilitate user interaction with the electronic device to view on a display of the device multiple images stored on the device for example sequentially or randomly, one after the other. Embodiments may cause the user of the electronic device to feel more realistically and tangibly the handling of the images, and to feel a high level of control in manipulating the technical functions and operation of the device. In addition, embodiments may provide the user with a desirable aesthetic effect that may provide an enhanced look and feel of the movement of images in the picture viewer.

In accordance with one embodiment there is provided a computer implemented method comprising, at an electronic device having a display screen: displaying a first image in a default position in a display area of the display screen; and replacing the first image with a second image in the display area of the display screen, wherein the replacing of the first image by the second image is animated in the display area by the second image moving in from the edge of the display area to the default position and the first image simultaneously moving away from the default position with translational speed slower than that of the movement of the second image.

In certain embodiments, the first and second images may move in the same direction. In certain embodiments, the second image can overlap the first image. In certain embodiments, the first image may move always at a translational speed that is slower than the simultaneous translational speed of the second image. In certain embodiments, during the animation the first image may move from the default position to a position such that the centre of the first image coincides with the leftmost edge of the display area. In certain embodiments, progress of the first image and the second image along their respective paths may be synchronised. In certain embodiments, the first image may be faded during the animation. In certain embodiments, the default position may be a centred position in the display area. In certain embodiments, the first and second images may be sized such that, when they are in the default position, they fill as much of the display area as possible. In certain embodiments, the aspect ratio of the images may be maintained. In certain embodiments, the display area may fill the display screen. In certain embodiments, the method may further comprise initiating the animation to replace the first image by the second image in response to user input to the electronic device. In certain embodiments, the user input may be a button press. In certain embodiments, the user input may be a gesture on a touch pad of the electronic device. In certain embodiments, the touch pad may be provided as a touch-sensitive overlay on the display screen, thus providing a touch-sensitive screen. In certain embodiments, the gesture may be a momentary, substantially single-position contact with the touch pad. In certain embodiments, the gesture may be a swipe gesture on the touch pad. In certain embodiments, one or more swipe gestures having a total swipe length covering the length of the display area may cause the second image to move from the edge of the screen to the default position. In certain embodiments, the direction of the translational movement of the images may correspond substantially to the direction of the swipe gesture. In certain embodiments, the progress of the images along their respective paths may be a function of the progress of the swipe gesture. In certain embodiments, should the swipe gesture end by a user lifting off the touch screen before the animation is completed, the speed of the animation may be continued at a speed which is a function of the speed of the swipe gesture when it ended. In certain embodiments, the translational speed of the images may be slowed at the end of the animation. In certain embodiments, a shadow may be overlaid on the edge of the first image. In accordance with another embodiment there is provided an electronic device comprising: a display screen; one or more processors; and memory comprising instructions which when executed by one or more of the processors cause the electronic device to: display a first image in a default position in a display area of the display screen; and replace the first image with a second image in the display area of the display screen, wherein the instructions cause the replacement of the first image by the second image to be animated in the display area by the second image moving in from the edge of the display area to the default position and the first image simultaneously moving away from the default position with translational speed slower than that of the movement of the second image.

In certain embodiments, the instructions may cause the first and second images to move in the same direction. In certain embodiments, the instructions may cause the second image to be able to overlap the first image. In certain embodiments, the instructions may cause the first image to move always at a translational speed that is slower than the simultaneous translational speed of the second image. In certain embodiments, during the animation, the instructions may cause the first image to move from the default position to a position such that the centre of the first image coincides with the leftmost edge of the display area. In certain embodiments, the instructions may cause the progress of the first image and the second image along their respective paths to be synchronised. In certain embodiments, the instructions may cause the first image to be faded during the animation. In certain embodiments, the instructions may cause the default position to be a centred position in the display area. In certain embodiments, the instructions may cause the first and second images to be sized such that, when they are in the default position, they fill as much of the display area as possible. In certain embodiments, the instructions may cause the aspect ratio of the images to be maintained. In certain embodiments, the instructions may cause the display area to fill the display screen. In certain embodiments, the instructions may cause the animation to replace the first image by the second image to be initiated in response to user input to the electronic device. In certain embodiments, the user input may be a button press. In certain embodiments, the user input may be a gesture on a touch pad of the electronic device. In certain embodiments, the touch pad may be provided as a touch-sensitive overlay on the display screen, thus providing a touch-sensitive screen. In certain embodiments, the gesture may be a momentary, substantially single-position contact with the touch pad. In certain embodiments, the gesture may be a swipe gesture on the touch pad. In certain embodiments, the instructions may cause one or more swipe gestures having a total swipe length covering the length of the display area to cause the second image to move from the edge of the screen to the default position. In certain embodiments, the instructions may cause the direction of the translational movement of the images to correspond substantially to the direction of the swipe gesture. In certain embodiments, the instructions may cause the progress of the images along their respective paths to be a function of the progress of the swipe gesture. In certain embodiments, should the swipe gesture end before the animation is completed, the instructions may cause the speed of the animation to be continued at a speed which is a function of the speed of the swipe gesture when it ended. In certain embodiments, the instructions may cause the translational speed of the images to be slowed at the end of the animation. In certain embodiments, the instructions may cause a shadow to be overlaid on the edge of the first image. In accordance with a further embodiment there is provided a computer program product comprising: memory comprising instructions which when executed by one or more of the processors of an electronic device having a display screen cause the electronic device to: display a first image in a default position in a display area of the display screen; and replace the first image with a second image in the display area of the display screen, wherein the instructions cause the replacement of the first image by the second image to be animated in the display area by the second image moving in from the edge of the display area to the default position and the first image simultaneously moving away from the default position with translational speed slower than that of the movement of the second image.

In accordance with yet another embodiment there is provided a computer implemented method comprising, at a portable electronic device having a touch- sensitive display screen: displaying a first image in a default position in a display area of the touch-sensitive display screen; and replacing the first image with a second image in the display area of the touch-sensitive display screen, wherein the replacing of the first image by the second image is animated in the display area by the second image moving in from the edge of the display area to the default position and the first image simultaneously moving away from the default position with translational speed slower than that of the movement of the second image, wherein the animation to replace the first image by the second image is initiated in response to a swipe gesture on the touch-sensitive display screen, and wherein the speed of the animation is correlated to the speed of the swipe gesture.

In accordance with yet another embodiment there is provided a portable electronic device comprising: a touch-sensitive display screen; one or more processors; and memory comprising instructions which when executed by one or more of the processors cause the electronic device to: display a first image in a default position in a display area of the touch-sensitive display screen; replace the first image with a second image in the display area of the touch-sensitive display screen, wherein the instructions cause the replacement of the first image by the second image to be animated in the display area by the second image moving in from the edge of the display area to the default position and the first image simultaneously moving away from the default position with translational speed slower than that of the movement of the second image; wherein the animation to replace the first image by the second image is initiated in response to a swipe gesture on the touch-sensitive display screen, and wherein the speed of the animation is correlated to the speed of the swipe gesture.

In accordance with yet another embodiment there is provided a computer program product comprising: memory comprising instructions which when executed by one or more of the processors of an electronic device having a display screen cause the electronic device to: display a first image in a default position in a display area of the touch-sensitive display screen; replace the first image with a second image in the display area of the touch-sensitive display screen, wherein the instructions cause the replacement of the first image by the second image to be animated in the display area by the second image moving in from the edge of the display area to the default position and the first image simultaneously moving away from the default position with translational speed slower than that of the movement of the second image; wherein the animation to replace the first image by the second image is initiated in response to a swipe gesture on the touch-sensitive display screen , and wherein the speed of the animation is correlated to the speed of the swipe gesture.

The disclosure generally relates to an electronic device, which, in embodiments described herein, is a portable electronic device. Examples of portable electronic devices include mobile, or handheld, wireless communication devices such as pagers, cellular phones, cellular smart-phones, wireless organizers, personal digital assistants, wirelessly enabled notebook computers, wirelessly enabled tablet computers and so forth. The portable electronic device may also be a portable electronic device without wireless communication capabilities, such as a handheld electronic game device, digital photograph album, tablet computer, digital camera, or other device.

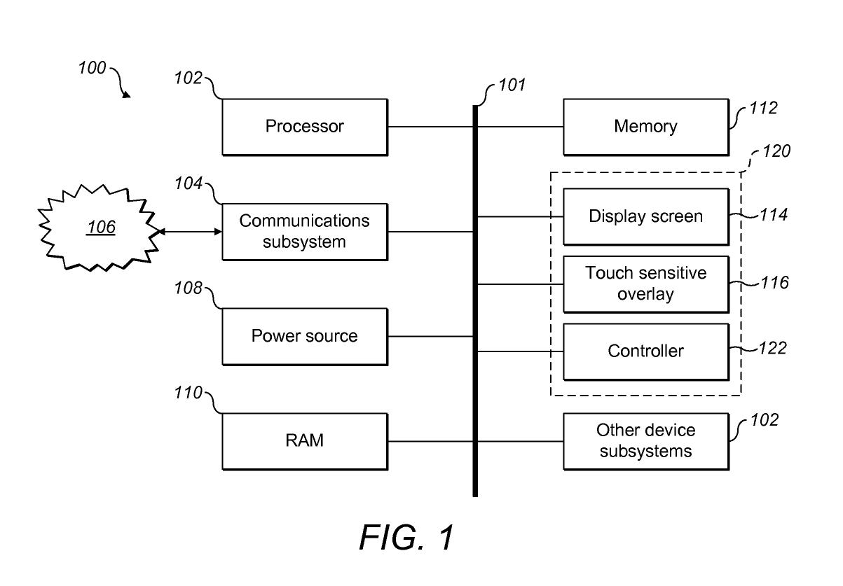

A block diagram of an example of a portable electronic device 100 is shown in FIG. 1. The portable electronic device 100 includes multiple components linked by a communications bus 101. A processor 102 controls the overall operation of the portable electronic device 100. Communication functions, including data and voice communications, are performed through a communication subsystem 104. The communication subsystem 104 receives messages from and sends messages to a wireless network 106 which may be any type of wireless network for voice communications or data communications or both. A power source 108, such as one or more rechargeable batteries or a port to an external power supply, powers the portable electronic device 100. The processor 102 interacts with other components of the electronic device including Random Access Memory (RAM) 110, memory 112, a display screen 114 with a touch-sensitive overlay 116 operably connected to an electronic controller 118 that together comprise a touch-sensitive display screen 120, and a camera 121. Other device subsystems 122 may be provided to enable additional functionality.

The touch-sensitive display screen 120 is controlled by the processor 102 to display on the display screen 114 information such as text, images and icons and a graphical user interface (GUI) of programs and of an operating system of the electronic device, which may be stored in the RAM 110 or memory 112 or both. A degree of user-interaction with the displayed information and with the graphical user interface (GUI) of programs and of an operating system is enabled through user manipulation of the touch-sensitive overlay 116 of the touch-sensitive display screen 120. The processor 102 interacts with the touch-sensitive overlay 116 via the electronic controller 118. The touch-sensitive display screen 120 may be of any suitable type, such as a capacitive, resistive, infrared, surface acoustic wave (SAW), optical, dispersive signal technology, acoustic pulse recognition, and so forth, as known in the art. A capacitive touch-sensitive display screen 120 includes a capacitive touch-sensitive overlay 116. The overlay 116 may be an assembly of multiple layers in a stack including, for example, a substrate, a ground shield layer, a barrier layer, one or more capacitive touch sensor layers separated by a substrate or other barrier, and a cover. The capacitive touch sensor layers may be any suitable material, such as patterned indium tin oxide (ITO).

One or more touches, also known as touch contacts or touch events, may be detected by the touch-sensitive display screen 120. Multiple simultaneous touches may be detected. The processor 102 may determine attributes of the touch, including a location of a touch, and may monitor any movement of the touch. Touch location and movement data may include an area of contact or a single point of contact, such as a point at or near a centre of the area of contact. The location of a detected touch may include x and y components, e.g., horizontal and vertical components, respectively. A signal is provided to the controller 116 in response to detection of a touch, and this is in turn provided to the processor 102 which processes the signal. Certain touches or combinations of touches are recognised as gestures that lead to certain manipulations or operations of the GUI or of the information presented on the touch-sensitive display screen 120. By performing certain gestures on the touch-sensitive display screen 120, a user can interact with the GUI and control the applications and operating system of the portable electronic device.

The memory 112 may store a plurality of images in digital format taken by the portable electronic device 100 using camera 121 or transmitted to the portable electronic device 100 over wireless network 106 via communication subsystem 104.

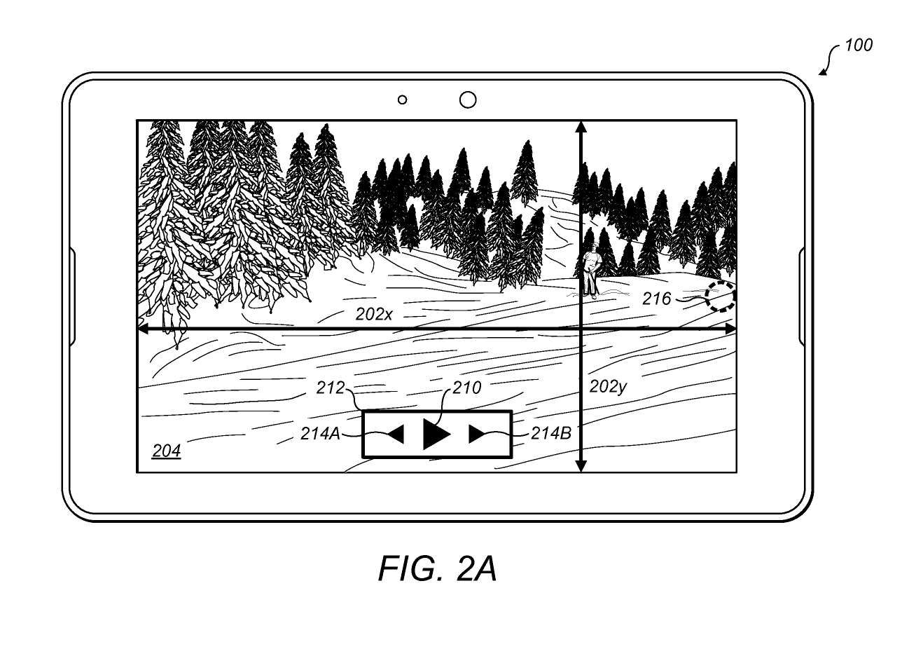

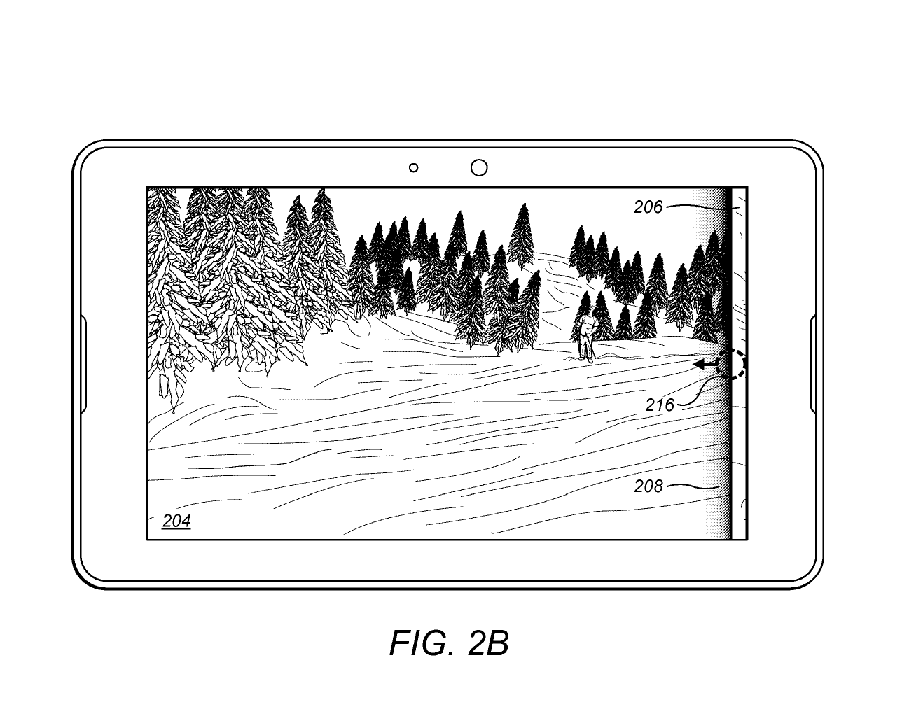

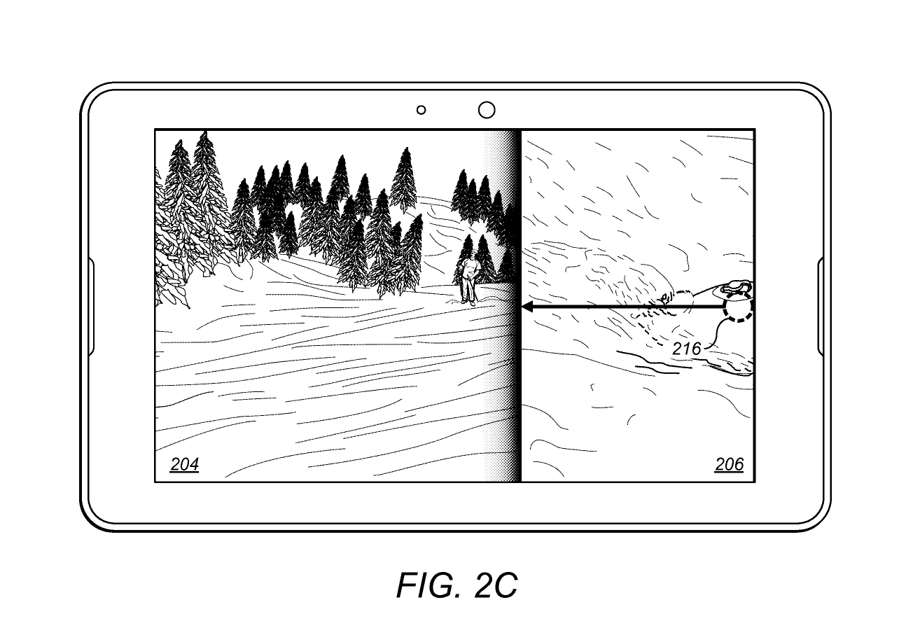

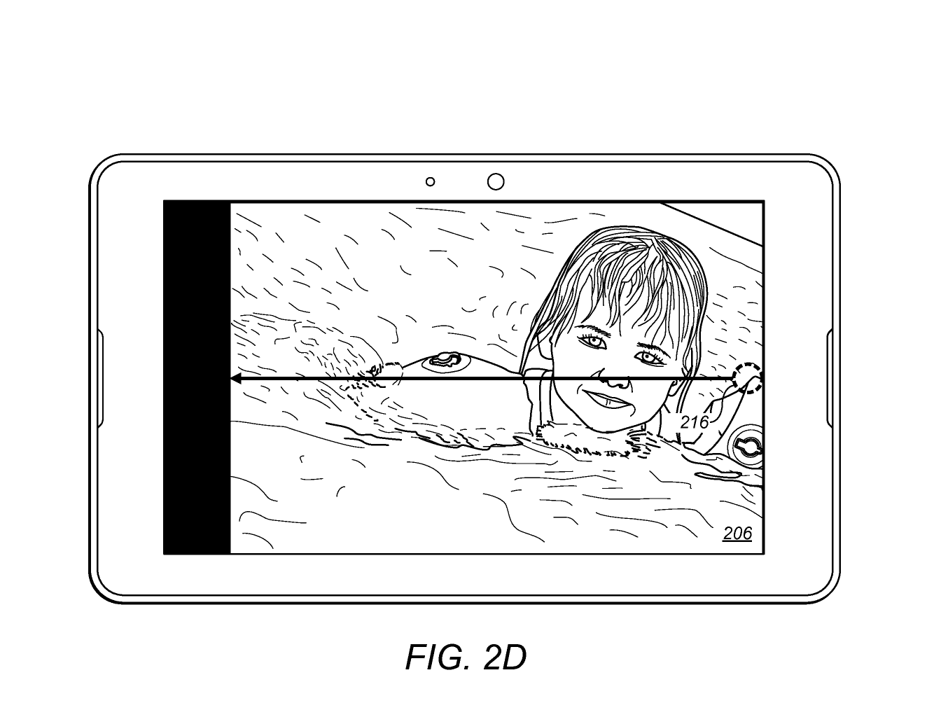

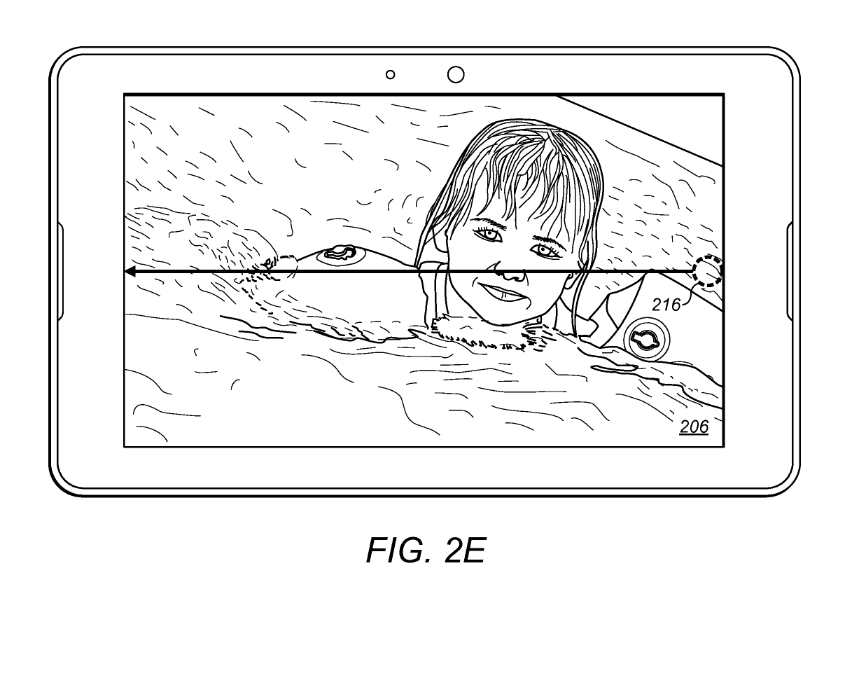

Memory 112 may store a picture viewer application that is usable to display on the display screen 114 images stored in memory 112. Referring to FIG. 2A, the picture viewer application may be loaded into RAM 110 and executed by processor 102 to provide a display area 202 (the extent of which is indicated in FIG. 2A by arrows 202x and 202y) on display screen 114 inside which images are displayed. Outside the display area 202 there may be, for example, a border, a menu bar, or any other GUI widget. The display area may be rectangular 202 as shown in FIG. 2A, although other shapes and configurations may be used, and may be defined by a template. In embodiments, as shown in FIG. 2A, the display area 202 may fill the display screen 114.

During operation, the picture viewer application causes an image to be displayed in the display area 202 in a default position, which is such that the image is centred in the display area 202. (In other embodiments, however, the default position of an image may be not centred in the display area 202. For example, the default position may be to one side.) In embodiments, when an image is displayed in the default position, only one image is displayed in the display area 202. However, during transition animations to change the displayed image from one to another, two images, or at least parts thereof, may be displayed on the display screen. In FIG. 2A, the display screen 114 of an embodiment of the electronic device 100 is showing an image 204 of a ski scene in this default, centred position. The first image 204 fills the entirety of the display area 202. In embodiments, the picture viewer application displays the images on the display 114 such that, when they are in the default, centred position, they fill as much of the display area 202 as possible. The images may be stretched to completely fill the display area 202, or the aspect ratio of the images may be maintained, such that the display area is not completely filled, and any non-filled areas may be filled with whitespace (which may actually be another colour including black) or a background.

The image 204 may have been selected by a user for display from a file system or a thumbnail representation, or may be a default or a random or a first or subsequent image of a user selected album or photostream or folder.

In embodiments, when the picture viewer application is to display a different image in the display area 202 (i.e. a second image 206 in place of the first image 204) the application causes an animation to be shown to achieve the transition from the first image 204 to the second image 206. The second image 206 may be the next image in the photostream/album/folder.

This transition animation is illustrated in sequence in FIGS. 2A-2E and, as will be explained below, may be initiated or controlled by a slideshow triggering the transition, a user input to change a displayed image, or a gesture detected by the touch-sensitive display screen 120, which, in embodiments may be a swipe gesture.

In FIG. 2A, the first image 204 is positioned in the default, centred position in which it fills the display area 202. In the transition animation, the first image 204 is to be replaced by a second image 206 of a girl swimming, which at the end of the animation is itself to be positioned in the default, centred position in which it fills the display area 202 (see FIG. 2E).

The next image to be displayed (i.e. the second image 206) always starts the animation from an initial position just off the right of the display area 202 in which its leftmost edge is at the rightmost edge of the display area.

During the animation, the second image 206 is moved leftwards into view in the display area 202 until it reaches the default position in the centre of the display area 202 where it is stopped. Simultaneously, during the animation the original image (in this case first image 204) is moved from its initial, default, centred position again leftwards in the same direction as the incoming second image, such that the centre of the first image 204 is moved to coincide with the leftmost edge of the display area 202. Thus during the transition animation, the first image 204 is always moved along a path over a distance which is always the same for each transition—i.e. half the width of the display area 202. Whereas, during the transition animation, the second image 206 is moved along a path over a distance which varies depending on the size of the second image 206 but is always greater than the distance over which the first image 204 is moved. Specifically, the second image 206 is moved along a path over a distance which is the sum of half the width of the display area 202 and half the width of the second image 206 (in the direction of the path of travel).

The animated movement of the images along their paths is synchronised so the images start and stop moving at the same time. During the animation, the two images are moved along their respective paths proportionally the same distance. i.e., when the first image 204 is x % (e.g. 75%) along it's path, the second image 206 is always also x % along it's respective path. However, as the second image 206 always moves along a path that is longer than the first image 204, the first image 204 always moves along its path at a slower rate (i.e. speed) than the second image 206 moves along its respective path.

The rate of progress of the images along their respective paths may be predetermined and may be constant or varying (i.e. where the animation is carried out in set time, for example in a slide show or a next/previous button press), or may be determined by a gesture performed by the user (e.g. the extent of completion of a swipe gesture).

Thus, in the first stage of the transition animation, shown in FIG. 2A, the picture viewer application displays the first image 204 starting in the default, centred position in display area 202 and the second image 206 starts from a position notionally outside the display area 202 with its leftmost edge touching the right edge of the display area 202 (although, of course, it is not actually displayed on the display screen 114 at this point in the animation).

After the transition animation has begun, the second image 206 is moved in a leftwards direction from its initial position just outside the display area 202 just into view, and the first image 204 is moved leftwards at a translational speed slower than the translational speed of the movement of the second image. The second image 206 can overlap the first image 204, and in the case shown in FIGS. 2A-2E, because both the images are sized to fill the display area when in the default, centred position, this overlapping happens immediately after the animation has started. In embodiments where both the first and the second images fill the display area, and as shown in FIG. 2, the synchronisation of their movements means the speed of movement of the first image is half the speed of movement of the second image. In this situation, over a full transition animation, the first image 204 will move leftwards over a path half the distance of the path of movement of the second image 206.

Of course, any portion of the first image 204 that is outside the display area or is overlapped by the second image 206, is not displayed, and any portion of the second image 206 that is not yet in display area 202 is also not displayed.

During the animation, a shadow 208 is superposed onto the first image 204 at its rightmost visible edge to imply a sensation that the incoming second image 206 is overlaying it. This is visible after the start of the animation as shown in FIG. 2B, where the incoming second image 206 and the shadow overlaying the first image 204 are animated so that, for example, within the first 1.5% or 2% of movement, the second image 206 and shadow 208 are faded in from transparent to solid, so that they do not appear suddenly on the display, which would otherwise create an undesirable visual effect. The sensation that the second image 206 is overlaying the first image 204 is further reinforced during the animation by the animation gradually fading out the first image 204 to black or background transparency, as it is increasingly overlaid by the second image 206.

FIG. 2B shows the transition animation shortly after it has begun, in which a strip of the second image 206 near its leftmost edge is displayed in display area 202. A strip of the first image 204, half the width of the strip of the second image 206 showing, is not shown at the left side of the first image 204, as this would be outside display area 202. Similarly, at the right side of the first image 204, a strip of the first image 204, again half the width of the strip that is showing of the second image 206, is not shown as it is overlaid or hidden by incoming strip of the second image 206. The visible portion of the first image 204 near the edge of the second image 206 is overlaid with shadow 208, and the first image 204 has begun to fade out.

FIG. 2C shows the animation in a more advanced stage in which more of the second image 206 and less of the first image 204 is visible, with the first image 204 being more faded out.

FIG. 2D shows the animation in a much more advanced stage where it is near completion in which the majority of the second image 206 is visible, and only a thin, faded strip of the first image 204 remains near the left edge of the display area 202.

FIG. 2E shows the animation completed, in which the second image 206 is shown in the default, centred position in the display area 202 in which it fills the display area 202.

After the animation has completed the animation may be repeated to replace the second image 206 with the next image by moving it in from the right edge of the display area in an overlaid manner, as described in relation to FIG. 2A-E.

To go backwards in the photostream/album/folder, or simply to move a replacing image in from the left hand side of the display area, the animation described above may be reversed, such that the outgoing image is moved to the right ‘off the top’ of the incoming image which is faded in as it moves in from the left. Alternatively, the animation set out in FIG. 2 may be adapted by making the incoming image move in from off the left of the screen and overlay and move the outgoing image, which is faded out as it moves to the right.

Also, although the above description explains the animation in relation to moving in from the left and right sides of the landscape-view display area only, embodiments in which analogous animated movements in the perpendicular direction and indeed, any other direction, are also possible. In other embodiments, the movement direction of the incoming and outgoing images during the image transition animation may be set along any path, for example a curved path, or even a user-defined path. Further, in embodiments, the path of motion of the incoming image may be different to the path of motion of the outgoing image. In these embodiments, the proportional progress of the images over the distance of their respective paths would be synchronised.

Nevertheless, the motion of the outgoing image is at a speed slower than that of the incoming image.

In embodiments, where the images are not sized to fill all of the display area, or where aspect ratio is maintained such that the images may be bordered with whitespace in the display area, the animated incoming images only overlay the outgoing images when they are positioned on top of them.

In embodiments the instruction to change between the images and initiate an image transition animation can be instigated by user input that starts a slideshow by, for example, performing a touch gesture on triangle 210 seen in FIG. 10, which is provided by the picture viewer application as a GUI control 212 overlaying the first image 201. In a slideshow, picture viewer application periodically performs image change instructions to slide sequentially or randomly through the photostream/album/folder images, performing transition animations every time the image is to be changed. Alternatively or in addition, the instruction to change between the images and initiate an image transition animation can be instigated by user input that indicates a desire to change to the previous or next image by the user performing a touch gesture on the triangles 214A, 214B shown in the GUI control 212. In the above-mentioned two types of user input (i.e. slideshow and previous/next image), the time taken to complete the animation may be predetermined. The rate of progress of the images along their paths of travel may be constant in these embodiments, at least for the majority of the transition animation, meaning that they move at a set speed. In embodiments, the rate of progress may vary during the transition animation. For example, the speed of the image movement may slow down towards the end of the transition animation.

In embodiments, however, the instruction to change between the images and initiate an image transition animation may instead or in addition be as a result of the user performing a ‘swipe’ gesture on the touch screen. As indicated in

FIGS. 2A-2E a swipe gesture comprises a user touching the touch-sensitive display screen 120 (indicated by the dashed circle 216) for example using a finger, and moving or dragging the finger across the screen (indicated by the arrow connected to dashed circle 216), while maintaining contact with the touch-sensitive display screen 120.

A complete swipe gesture across the full width of the display area 202 or the touch-sensitive display screen 120 may result in one complete transition animation. The progress of the transition animation, and thus the progress of the images along their respective paths may be dependent on the progress of the user in completing the transition animation. Thus a swipe gesture that is x % completed means that the first and second images have moved x % along the distance of their paths of movement. Thus if the user slows down, stops, or reverses the swipe gesture, the movement of the images also mirrors the swipe gesture.

A swipe in the direction right to left as shown in FIG. 2A-2E may cause the images to move forwards through the photostream/album/folder images, whereas a swipe in the direction left to right swipe moves backwards. Whatever the direction of the swipe (i.e. forwards or backwards through the carousel), the transition animation is always the same. In the case of two images that fill the display area, the incoming image will move in at twice the rate of the outgoing image, which is faded out.

The speed of the swiping gesture thus controls the speed of the transition between the images. Thus if the user keeps his finger on the touch-sensitive display screen 120 while executing a swipe his finger effectively controls the transition animation. This may give the sensation that the incoming image is stuck to his finger, or that he is dragging the incoming image along, providing a haptic control over the GUI image transitions. Moving his finger forwards faster and slower will control the animation such that the incoming and outgoing images move simultaneously at the concordant speed (with the outgoing image moving slower than the incoming image). Stopping mid-swipe gesture causes the animation to be stopped, and reversing direction causes the image to be animated out the way it was animated in.

If, mid-way through a swipe gesture, the user lifts his finger off the touch-sensitive display screen 120 (i.e. performs a ‘flick’ gesture), the transition animation is continued to its end at the speed at which the user's finger was moving when it was lifted off (the flick speed). Alternatively, or in addition, if he lifts his finger off mid-swipe, the animation may continue to completion at a predetermined speed or in a predetermined time. This may happen where the user's swipe speed at the time of lifting off the touch-sensitive display screen 120 is zero, or below a threshold level. The animation may slow down at the end of the transition.

The initiation of the image transition animation by swipe gesture may be position sensitive, meaning that the user may have to begin his swipe by touching the touch sensitive display screen 120 near its edge where the next or previous image is positioned off-screen. Alternatively, initiation of the image transition animation by swipe gesture may not be position sensitive, meaning that the user may begin his swipe gesture by touching anywhere on the display area 220 or on the touch sensitive display screen 120.

Where the path of movement of the incoming image is different, or curved, the swipe gesture to instigate the animation may need to be conducted along this path.

In the embodiments described above, one full swipe across the display area 202 or across the touch-sensitive display screen 120 (for a full screen display area) results in the full animation of the incoming picture moving in from just outside the screen into the centered (default) position, and the outgoing image moving away and fading into the background. I an alternative implementation, where the transition animation is not automatically completed when the user lifts his finger off mid-swipe, the user may complete the transition animation by making multiple swipe gestures that are each shorter in length than one complete swipe across the display area 202, but which when taken together have a total length of one complete swipe gesture across the display area 202. Alternatively the user's gesture movement may be exaggerated so that less than one full swipe across the display area 202 is needed to complete the image transition animation.

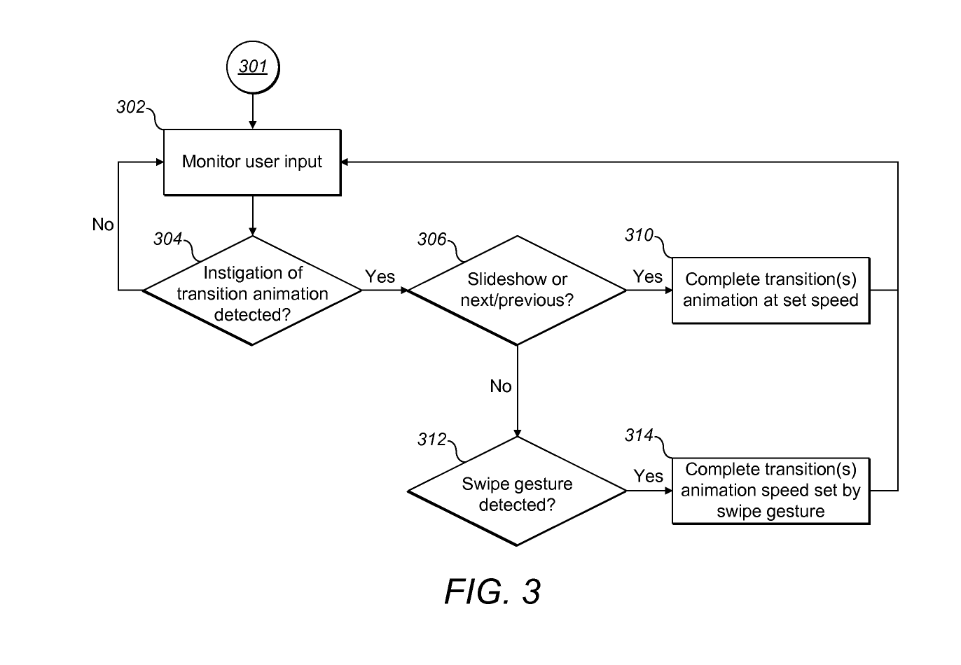

FIG. 3 shows a flow chart of a component of an embodiment of program logic usable in a picture viewer application of the portable electronic device 100 shown in FIGS. 1 and 2 to perform the image transition animation.

Starting at 301 the user input is monitored in a loop 302 to detect an instigation of an image transition animation by a user 304 performing a touch or swipe gesture on the touch sensitive display panel 120.

If a slideshow or next/previous input gesture is detected 306 the transition animation is completed at a set speed. In the case of a slide show, multiple transition animations are completed until the slideshow ends.

If a swipe gesture is detected 312 then the transition animation is completed at a speed commensurate to the speed of the swipe gesture in accordance with the above description.

Thereafter the user input is again monitored 302.

The various embodiments presented above are merely examples and variations of the innovations described herein will be apparent to persons of ordinary skill in the art. As embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

1. A computer implemented method comprising, at an electronic device having a display screen:
displaying a first image in a default position in a display area of the display screen; and
replacing the first image with a second image in the display area of the display screen, wherein the replacing of the first image by the second image is animated in the display area by the second image moving in from the edge of the display area to the default position and the first image simultaneously moving away from the default position with translational speed slower than that of the movement of the second image.

2. The method of claim 1, wherein the first and second images move in the same direction.

3. The method of claim 1, wherein the second image can overlap the first image.

4. The method of claim 1, wherein the first image moves always at a translational speed that is slower than the simultaneous translational speed of the second image.

5. The method of claim 1, wherein during the animation the first image moves from the default position to a position such that the centre of the first image coincides with the leftmost edge of the display area.

6. The method of claim 1, wherein progress of the first image and the second image along their respective paths is synchronised.

7. The method of claim 1, wherein the first image is faded during the animation.

8. The method of claim 1, wherein the default position is a centred position in the display area.

9. The method of claim 1, wherein the first and second images are sized such that, when they are in the default position, they fill as much of the display area as possible.

10. The method of claim 9, wherein the aspect ratio of the images is maintained.

11. The method of claim 1, wherein the display area fills the display screen.

12. The method of claim 1, further comprising initiating the animation to replace the first image by the second image in response to user input to the electronic device.

13. The method of claim 12, wherein the user input is a button press.

14. The method of claim 12, wherein the user input is a gesture on a touch pad of the electronic device.

15. The method of claim 14, wherein the touch pad is provided as a touch-sensitive overlay on the display screen, thus providing a touch-sensitive screen.

16. The method of claim 14, wherein the gesture is a momentary, substantially single-position contact with the touch pad.

17. The method of claim 14, wherein the gesture is a swipe gesture on the touch pad.

18. The method of claim 17, wherein one or more swipe gestures having a total swipe length covering the length of the display area causes the second image to move from the edge of the screen to the default position.

19. The method of claim 17, wherein the direction of the translational movement of the images corresponds substantially to the direction of the swipe gesture.

20. The method of claim 17, wherein the progress of the images along their respective paths is a function of the progress of the swipe gesture.

21. The method of claim 20, wherein, should the swipe gesture end by a user lifting off the touch screen before the animation is completed, the speed of the animation is continued at a speed which is a function of the speed of the swipe gesture when it ended.

22. The method of claim 1, wherein the translational speed of the images is slowed at the end of the animation.

23. The method of claim 1, wherein a shadow is overlaid on the edge of the first image.

24. An electronic device comprising:
a display screen;
one or more processors; and
memory comprising instructions which when executed by one or more of the processors cause the electronic device to:
display a first image in a default position in a display area of the display screen; and
replace the first image with a second image in the display area of the display screen, wherein the instructions cause the replacement of the first image by the second image to be animated in the display area by the second image moving in from the edge of the display area to the default position and the first image simultaneously moving away from the default position with translational speed slower than that of the movement of the second image.

25. A computer program product comprising:
memory comprising instructions which when executed by one or more of the processors of an electronic device having a display screen cause the electronic device to:
display a first image in a default position in a display area of the display screen; and
replace the first image with a second image in the display area of the display screen, wherein the instructions cause the replacement of the first image by the second image to be animated in the display area by the second image moving in from the edge of the display area to the default position and the first image simultaneously moving away from the default position with translational speed slower than that of the movement of the second image.
